(19) United States
(12) Patent Application Publication
(10) Pub. No.: US 2006/0291730 A1
(43) Pub. Date: Dec. 28, 2006

(54) Method and apparatus for processing JPEG data in mobile communication terminal

(76) Inventors: Ho Hee Lee, Seoul (KR); Jae Hwan Lee, Seoul (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/472,584

(22) Filed: Jun. 21, 2006

(30) Foreign Application Priority Data
Jun. 27, 2005 (KR) 10-2005-0055735

(51) Int. Cl. G06K 9/36

(52) U.S. Cl. 382/233

(57) ABSTRACT

Provided is a device for resizing a JPEG image having a nonstandard size at a predetermined ratio to output the resized image on a display unit without distortion in a mobile communication terminal. A method for processing a JPEG image in a mobile communication terminal comprises extracting image sizes (X, Y) from JPEG data of a JPEG file stored in an image data storing unit, comparing display area sizes (dx, dy) of the display unit with the image sizes (X, Y), and resizing the image sizes (X, Y) while maintaining the ratio of width:length in consideration of the display area sizes (dx, dy) to output the resized image to the display unit.

### BACKGROUND OF THE INVENTION

1. Field of the Invention

The present invention generally relates to a device and method for processing JPEG data in a mobile communication terminal, and more specifically, to a technology of resizing a JPEG image of a nonstandard size while maintaining the original ratio of width:length to display the image on a display unit without distortion in a mobile communication terminal.

2. Description of the Related Art

Due to various functions of a mobile communication terminal, the mobile communication terminal has a built-in camera to take a certain photograph, which supports a function so that a user can watch this image by album view. When a user takes an image with a mobile communication terminal, the image is taken and stored at predetermined standards such as VGA (640×480), QVGA(320×240), SQCIF(160×120), QCIF(176×144), MEGA(1280×1024), 2MEGA(1600×1200). The photographed image signal is generally compressed by a JPEG, stored in an inner memory, and then outputted on a display unit in user's request. The image photographed through the mobile communication terminal is adjusted at the ratio of width:length of a LCD panel which is the display unit. When JPEG data are decoded for replaying the image and its size values are applied without change, an undistorted image can be outputted.

However, when a mobile communication terminal replays an externally downloaded image, the image outputted on the LCD panel can be distorted if the width:length ratio of the image is not adjusted to that of the LCD panel as shown in FIG. 2.

FIG. 1 is an example illustrating an original JPEG photograph (667×1000) downloaded in a mobile communication terminal, and FIG. 2 is an example illustrating when the photograph of FIG. 1 is outputted on a LCD panel (240×180) in a conventional mobile communication terminal.

Referring to FIG. 2, it is shown that the image of FIG. 1 is enlarged into the horizontal direction. Since the vertical ratio of the image is large while the horizontal ratio of the LCD panel is large, the image is shown to be enlarged into the horizontal direction.

Accordingly, when the width: length of the externally downloaded image is not adjusted to that of the LCD panel, the initially downloaded source image outputted to the LCD panel is shown to be enlarged to the horizontal direction or the vertical direction.

### SUMMARY OF THE INVENTION

Various embodiments of the present invention are directed at providing a device of resizing a JPEG image of a nonstandard size while maintaining the original ratio of width:length to display the image on a display unit without distortion in a mobile communication terminal.

According to one embodiment of the present invention, a method for processing JPEG data in a mobile communication terminal comprises a first step of extracting image sizes (X, Y) from JPEG data from a JPEG file stored in an image data storing unit, a second step of comparing the image sizes (X, Y) with display area sizes (dx, dy) of a display unit, and a third step of resizing the image sizes (X, Y) in consideration of the display area sizes (dx, dy) while maintaining the aspect (width:length) ratio of the image sizes (X, Y) based on the comparison result to output the resized image sizes to the display unit.

Preferably, the third step comprises a (3-1)th step of outputting size values (decode_x, decode_y) for resizing the JPEG data adjustable to the display area sizes (dx, dy) so that the image sizes (X, Y) is displayed while maintaining the aspect (width:length) ratio, and a (3-2)th step of decoding the JPEG data based on the size values (decode_x, decode_y) to output the decoded data to the display area.

Preferably, the (3-1)th step comprises a (3-1-1)th step of comparing the display area sizes (dx, dy) with the image sizes (X, Y), and a (3-1-2)th step of outputting the horizontal size X and the vertical size Y of the image as the size values (decode_x, decode_y) for the JPEG data when the image sizes (X, Y) are smaller than the display area sizes (dx, dy).

When the horizontal size X of the image is smaller than the horizontal size dx of the display area (X<dx) and the vertical size Y of the image is larger than or the same as the vertical size dy of the display area (Y>dy), the (3-1)th step further comprises a (3-1-3)th step of outputting (X*dy)/Y and dy as the size values (decode_x, decode_y) for the JPEG data.

When the horizontal size X of the image is larger than or the same as the horizontal size dx of the display area (X>dx) and the vertical size Y of the image is smaller than the vertical size dy of the display area (Y<dy), the (3-1) step further comprises a (3-1-4)th step of outputting dx and (Y*dx)/X as the size values (decode_x, decode_y) for the JPEG data.

When the ratio (X/dx) of the horizontal size X of the image to the horizontal size dx of the display area is larger than or the same as the ratio (Y/dy) of the vertical size Y of the image to the vertical size dy of the display area ((X/dx)≧(Y/dy)), the (3-1)th step further comprises a (3-1-5)th step of outputting dx and (Y*dx)/X as the size values (decode_x, decode_y) for the JPEG data.

When the ratio (X/dx) of the horizontal size X of the image to the horizontal size dx of the display area is smaller than the ratio (Y/dy) of the vertical size Y of the image to the vertical size dy of the display area to ((X/dx)<(Y/dy)), the (3-1)th step further comprises a (3-1-6)th step of outputting (X*dy)/Y and dy as the size values (decode_x, decode_y) for the JPEG data.

According to one embodiment of the present invention, a device for processing JPEG data in a mobile communication terminal is configured to resize image sizes (X, Y) of a JPEG file stored in an image data storing unit while maintaining the ratio of width:length of the source image, thereby outputting an undistorted image on a display area of the mobile communication terminal.

Preferably, the device for processing JPEG data comprises an image size extracting unit configured to extract image sizes (X, Y) from JPEG data of the JPEG file, a image size comparing unit configured to compare the previously registered display area sizes (dx, dy) of a display unit with the image sizes (X, Y) to output size values (decode_x, decode_y) for resizing the image size while maintaining the aspect (width:length) ratio of the image sizes (X, Y), and a decoding unit configured to decode the JPEG data with the size values (decode_x, decode_y) to output an undistorted image to the display unit.

When the image sizes (X, Y) are smaller than the display area sizes (dx, dy), the size comparison unit outputs the horizontal size X and the vertical size Y of the image as the size values (decode_x, decode_y) to the JPEG data.

When the horizontal size X of the image is smaller than the vertical size dx of the display area (X<dx) and the vertical size Y of the image is larger than or the same as the vertical size dy of the display area (Y≧dy), the size comparison unit outputs (X*dy)/Y and dy as the size values (decode_x, decode_y) for the JPEG data.

When the horizontal size X of the image is larger than or the same as the horizontal size dy of the display area (X≧dx) and the vertical size Y of the image is smaller than the vertical size dy of the display area (Y<dy), the size comparison unit outputs dx and (Y*dx)/X as the size values (decode_x, decode_y) for the JPEG data.

When the ratio (X/dx) of the horizontal size X of the image to the horizontal size dx of the display area is larger than or the same as the ratio (Y/dy) of the vertical size Y of the image to the vertical size dy of the display area ((X/dx)≧(Y/dy)), the size comparison unit outputs dx and (Y*dx)/X as the size values (decode_x, decode_y) for the JPEG data.

When the ratio (X/dx) of the horizontal size X of the image to the horizontal size dx of the display area is smaller than the ratio (Y/dy) of the vertical size Y of the image to the vertical size dy of the display area to ((X/dx)<(Y/dy)), the size comparison unit outputs (X*dy)/Y and dy as the size values (decode_x, decode_y) to the JPEG data.

### BRIEF DESCRIPTION OF THE DRAWINGS

Other aspects and advantages of the present invention will become apparent upon reading the following detailed description and upon reference to the drawings in which:

FIG. 1 is an example illustrating an original JPEG photograph (667×1000) downloaded in a mobile communication terminal;

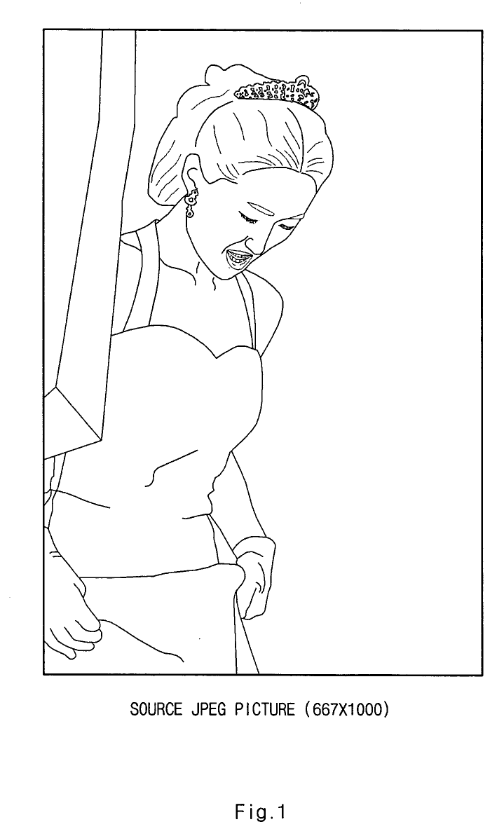

FIG. 2 is an example illustrating when the photograph of FIG. 1 is outputted on a LCD panel (240×180) in a conventional mobile communication terminal;

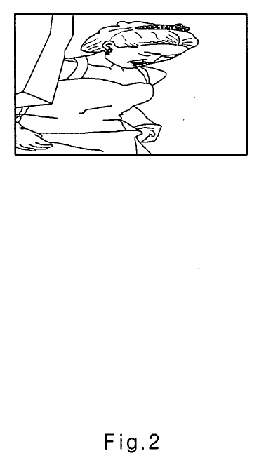

FIG. 3 is an example illustrating when the photograph of FIG. 1 is outputted on a LCD panel (240×180) in a mobile communication terminal according to an embodiment of the present invention;

FIG. 4 is a block diagram illustrating a device for processing JPEG data in a mobile communication terminal according to an embodiment of the present invention;

FIG. 5 is a diagram illustrating a control unit of FIG. 4; and

FIG. 6 is a flow chart illustrating a method for processing JPEG data in a mobile communication terminal according to an embodiment of the present invention.

### DETAILED DESCRIPTION OF THE EXEMPLARY EMBODIMENTS

The present invention will be described in detail with reference to the accompanying drawings. Wherever possible, the same reference numbers will be used throughout the drawings to refer to the same or like parts.

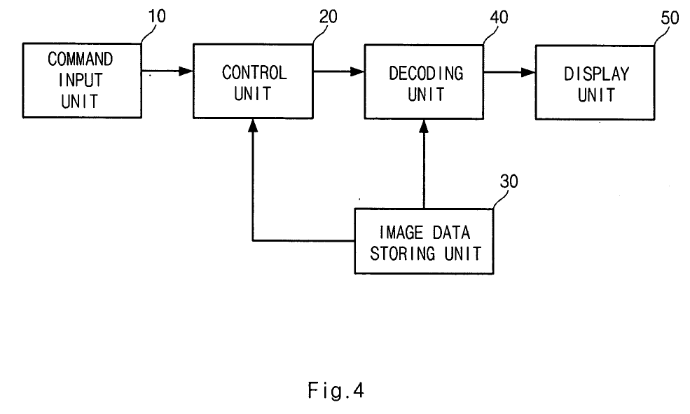

FIG. 4 is a block diagram illustrating a device for processing JPEG data in a mobile communication terminal according to an embodiment of the present invention.

In this embodiment, a device for processing JPEG data in a mobile communication terminal comprises a command input unit 10, a control unit 20, an image data storing unit 30, a decoding unit 40 and a display unit 50 as shown in FIG. 4.

When an image is downloaded from an external device through a data cable or an image stored in a SD card is downloaded into a mobile communication terminal, a JPEG file corresponding to the downloaded image is stored in the image data storing unit 30 by the control unit 20. When a JPEG file is downloaded through wireless Internet, the JPEG file downloaded by the control unit 20 is stored in the image data storing unit 30. FIG. 4 does not show the structure for downloading the JPEG file corresponding to the image.

JPEG (Joint Photographic Coding Experts Group) is a standard technology of compressing still image information like photographs for communication. JPEG data obtained by compressing image data based on the JPEG are decoded to output the JPEG file.

When a menu “album view” is selected for replaying images through the command input unit 10 while the JPEG file is stored in the image data storing unit 30, the control unit 20 loads the corresponding JPEG file from the image data storing unit 30, extracts image sizes (X, Y) of the JPEG file from JPEG data corresponding to the JPEG file, compares display area sizes (dx, dy) of the display unit 50 with the extracted image sizes (X, Y), and calculates size values (decode_x, decode_y) for displaying the JPEG file to output the calculated size values (decode_x, decode_y) to the decoding unit 40.

The decoding unit 40 decodes the JPEG data transmitted from the image data storing unit 30 with the size values (decode_x, decode_y) to output an image signal corresponding to the resized image data. The image signal outputted through the display unit 50 is an image whose size is resized to be adjustable to a LCD panel that is the display unit 50 while the ratio of width:length maintains the ratio of width:length of the source image. As a result, an undistorted image is outputted to the display unit 50.

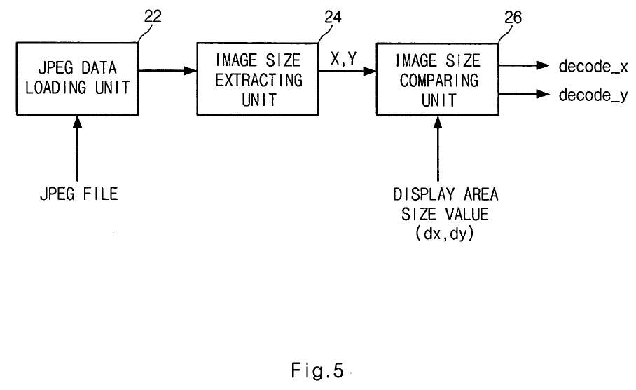

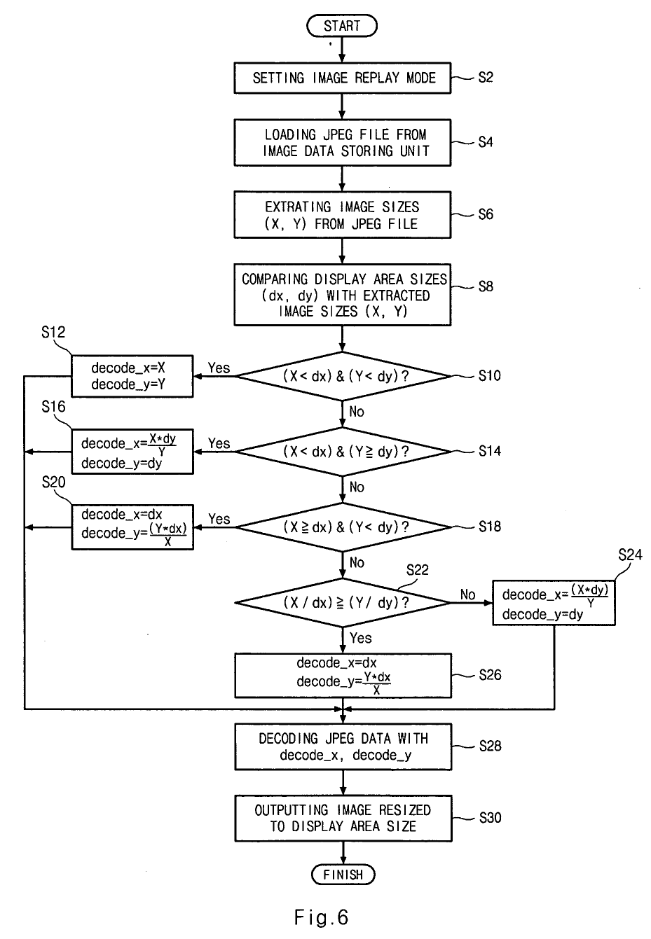

Hereinafter, a method for processing JPEG data in a mobile communication terminal according to an embodiment of the present invention is specifically described with reference to FIGS. 5 and 6.

When an image replay mode, that is, “album view” is selected through the command input unit 10 (S2), a JPEG data loading unit 22 of the control unit 20 loads JPEG data corresponding to a JPEG file of a specific file name stored in the image data storing unit 30 to transmit the JPEG data to an image size extracting unit 24 (S4).

The image size extracting unit 24 extracts image sizes (X, Y) structured by the JPEG data from a header of the JPEG data to transmit the extracted image sizes (X, Y) to a image size comparing unit 26.

Thereafter, the image size comparing unit 26 compares the image sizes (X, Y) with display area sizes (dx, dy) of the display unit 50 previously registered in an inner memory (not shown) (S8).

The image size comparing unit 26 identifies whether the image sizes (X, Y) are smaller than the display area sizes (dx, dy) (S10), and outputs the horizontal size X and the vertical size Y of the image as the size values (decode_x, decode_y) (S12) when the image sizes (X, Y) are smaller than the display area sizes (dx, dy) (Yes in S10).

However, the image size comparing unit 26 identifies whether the image sizes (X, Y) are X<dx and Y≧dy when the image sizes (X, Y) are not smaller than the display area sizes (dx, dy) (No in S10).

When the image sizes (X, Y) are X<dx and Y≧dy (Yes in S14), the image size comparing unit 26 outputs (X*dy)/Y and dy obtained by regulating size values (decode_x, decode_y) to the JPEG data (S16)

When the image sizes (X, Y) are not X<dx and Y≧dy (No in S14), the image size comparing unit 26 identifies whether the image sizes (X, Y) are X≧dx and Y<dy (S18).

When the image sizes (X, Y) are X≧dx and Y<dy (Yes in S18), the image size comparing unit 26 outputs dx and (Y*dx)/X obtained by regulating size values (decode_x, decode_y) to the JPEG data (S20).

When the image sizes (X, Y) are not X≧dx and Y<dy (No in S18), the image size comparing unit 26 identifies whether the image sizes are (X/dx)≧(Y/dy) (S22) to compare the ratio (Y/dy) of the vertical size Y of the image to the vertical size dy of the display area dy with the ratio (X/dx) of the horizontal size X of the image to the horizontal size dx of the display area.

When the ratio is (X/dx)≧(Y/dy) (Yes in S22), the image size comparing unit 26 outputs dx and (Y*dx)/X obtained by regulating size values (decode_x, decode_y) to the JPEG data (S26).

When the ratio is not (X/dx)≧(Y/dy), that is, (X/dx)<(Y/dy) (No in S22), the image size comparing unit 26 outputs (X*dy)/Y and dy obtained by regulating size values (decode_x, decode_y) to the JPEG data (S24).

The decoding unit 40 decodes the JPEG data (S28) with the size values (decode_x, decode_y) transmitted from the image size comparing unit 26 so that the horizontal size X of the image to the JPEG data becomes the size value decode_x and the vertical size Y of the image to the JPEG data becomes the size value decode_y.

Since the decoding unit 40 decodes the JPEG data depending on the size values (decode_x, decode_y), the JPEG data having the maintained ratio of width:length of the source image is outputted to the display unit 50 (S30) while the size of the image is regulated to be adjustable to the display area size.

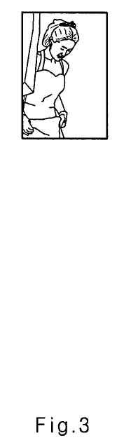

According to the method for processing JPEG data in a mobile communication terminal in the embodiment of the present invention, even when the JPEG image of 667(X)×1000(Y) is outputted to the LCD panel of 240(dx)×180(dy), the original JPEG image size is regulated into 120((X*dy)/Y)×180(dy) so that the undistorted image is displayed as shown in FIG. 3.

As described above, in a device and a method for processing JPEG data in a mobile communication terminal according to an embodiment of the present invention, a resized image while maintaining the ratio of width:length of the image to a loaded JPEG file based on a size of a display unit of the mobile communication terminal is displayed on the display unit of the mobile communication terminal so that an image of a nonstandard JPEG file can be outputted without distortion.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. Thus, the embodiments were chosen and described in order to explain the principles of the invention and its practical application to enable one skilled in the art to utilize the invention in various embodiments and with various modifications as are suited to the particular use contemplated.

What is claimed is:

1. A method for processing JPEG data in a mobile communication terminal, the method comprising:
a first step of extracting image sizes (X, Y) from JPEG data from a JPEG file stored in an image data storing unit;
a second step of comparing the image sizes (X, Y) with display area sizes (dx, dy) of a display unit; and
a third step of resizing the image sizes (X, Y) in consideration of the display area sizes (dx, dy) while maintaining the aspect (width:length) ratio of the image sizes (X, Y) based on the comparison result to output the resized image sizes to the display unit.

2. The method according to claim 1, wherein the third step comprises:
a (3-1)th step of outputting size values (decode_x, decode_y) for resizing the JPEG data adjustable to the display area sizes (dx, dy) so that the image sizes (X, Y) is displayed while maintaining the aspect (width:length) ratio; and
a (3-2)th step of decoding the JPEG data based on the size values (decode_x, decode_y) to output the decoded data to the display area.

3. The method according to claim 2, wherein the (3-1)th step comprises:
a (3-1-1)th step of comparing the display area sizes (dx, dy) with the image sizes (X, Y); and
a (3-1-2)th step of outputting the horizontal size X and the vertical size Y of the image as the size values (decode_x, decode_y) for the JPEG data when the image sizes (X, Y) are smaller than the display area sizes (dx, dy).

4. The method according to claim 3, wherein the (3-1)th step further comprises a (3-1-3)th step of outputting (X*dy)/Y and dy as the size values (decode_x, decode_y) for the JPEG data when the horizontal size X of the image is smaller than the horizontal size dx of the display area (X<dx) and the vertical size Y of the image is larger than or the same as the vertical size dy of the display area (Y≧dy).

5. The method according to claim 4, wherein the (3-1) step further comprises a (3-1-4)th step of outputting dx and (Y*dx)/X as the size values (decode_x, decode_y) for the JPEG data when the horizontal size X of the image is larger than or the same as the horizontal size dx of the display area (X≧dx) and the vertical size Y of the image is smaller than the vertical size dy of the display area (Y<dy).

6. The method according to claim 5, wherein the (3-1)th step further comprises a (3-1-5)th step of outputting dx and (Y*dx)/X as the size values (decode_x, decode_y) for the JPEG data when the ratio (X/dx) of the horizontal size X of the image to the horizontal size dx of the display area is larger than or the same as the ratio (Y/dy) of the vertical size Y of the image to the vertical size dy of the display area ((X/dx)≧(Y/dy)).

7. The method according to claim 6, wherein the (3-1)th step further comprises a (3-1-6)th step of outputting (X*dy)/Y and dy as the size values (decode_x, decode_y) for the JPEG data when the ratio (X/dx) of the horizontal size X of the image to the horizontal size dx of the display area is smaller than the ratio (Y/dy) of the vertical size Y of the image to the vertical size dy of the display area ((X/dx)<(Y/dy)).

8. A device for processing JPEG data in a mobile communication terminal configured to resize image sizes (X, Y) of a JPEG file stored in an image data storing unit while maintaining the ratio of width:length of the source image, thereby outputting an undistorted image on a display area of the mobile communication terminal.

9. The device according to claim 8, wherein the device for processing JPEG data comprises:
an image size extracting unit configured to extract image sizes (X, Y) from JPEG data of the JPEG file;
a image size comparing unit configured to compare the previously registered display area sizes (dx, dy) of a display unit with the image sizes (X, Y) to output size values (decode_x, decode_y) for resizing the image size while maintaining the aspect (width:length) ratio of the image sizes (X, Y); and
a decoding unit configured to decode the JPEG data with the size values (decode_x, decode_y) to output an undistorted image to the display unit.

10. The device according to claim 9, wherein the size comparison unit outputs the horizontal size X and the vertical size Y of the image as the size values (decode_x, decode_y) to the JPEG data when the image sizes (X, Y) are smaller than the display area sizes (dx, dy).

11. The device according to claim 9, wherein the size comparison unit outputs (X*dy)/Y and dy as the size values (decode_x, decode_y) for the JPEG data when the horizontal size X of the image is smaller than the horizontal size dx of the display area (X<dx) and the vertical size Y of the image is larger than or the same as the vertical size dy of the display area (Y≧dy).

12. The device according to claim 11, wherein the size comparison unit outputs dx and (Y*dx)/X as the size values (decode_x, decode_y) for the JPEG data when the horizontal size X of the image is larger than or the same as the horizontal size dx of the display area (X≧dx) and the vertical size Y of the image is smaller than the vertical size dy of the display area (Y<dy).

13. The device according to claim 12, wherein the size comparison unit outputs dx and (Y*dx)/X as the size values (decode_x, decode_y) for the JPEG data when the ratio (X/dx) of the horizontal size X of the image to the horizontal size dx of the display area is larger than or the same as the ratio (Y/dy) of the vertical size Y of the image to the vertical size dy of the display area ((X/dx)≧(Y/dy)).

14. The device according to claim 13, wherein the size comparison unit outputs (X*dy)/Y and dy as the size values (decode_x, decode_y) for the JPEG data when the ratio (X/dx) of the horizontal size X of the image to the horizontal size dx of the display area is smaller than the ratio (Y/dy) of the vertical size Y of the image to the vertical size dy of the display area ((X/dx)<(Y/dy)).
